(19) United States
(12) Patent Application Publication
(10) Pub. No.: US 2015/0128395 A1
(43) Pub. Date: May 14, 2015

(54) CUTTING TOOL HOLDER EXTRACTION DEVICE

(71) Applicants: Jeremiah L. Jonsrud, Saint Paul, VA (US); Eric Paul Helsel, New Enterprise, PA (US)

(72) Inventors: Jeremiah L. Jonsrud, Saint Paul, VA (US); Eric Paul Helsel, New Enterprise, PA (US)

(73) Assignee: Kennametal Inc., Latrobe, PA (US)

(21) Appl. No.: 14/600,331

(22) Filed: Jan. 20, 2015

(51) Int. Cl. B25B 27/02

(52) U.S. Cl. CPC B25B 27/023; B25B 27/026
USPC 29/252; 29/256

(57) ABSTRACT

A cutting tool holder extraction devise comprising a cup, having a back portion having a rearward socket and a front portion having a forward tool socket, and a spacer section having an axial bore with a back orifice opening in the bottom of the rearward socket and a front orifice opening in the bottom of the tool socket; an expandable jack, the jack having an axial bore, and a front face; the front face of the jack is removably engageable with the rearward socket of the cup; a threaded bolt, the bolt having a front end and a rear end, the bolt removably disposable through the cup bore and through the jack bore; and at least one nut, removably attachable to the threaded bolt.

### BACKGROUND OF THE INVENTION

The invention pertains to a cutting tool holder extraction device that is useful in association with machines for impinging a substrate or earth strata such as, for example, asphaltic roadway material, coal deposits, mineral formations and the like. More particularly, the invention pertains to a cutting tool holder extraction device, as well as to the individual components of the device.

One typically uses such a device in conjunction with a rotatable drum or driven member. The driven member rotates in such a fashion to drive the rotatable cutting bit or tool into earth strata to disintegrate the same into smaller pieces including fine particulates, i.e., cutting debris. The cutting bit or tool, the tool holder and the base are each subjected to considerable stresses during mining operations, road milling operations or other like operations that can lead to wear and/or failure of one or more of the cutting tool assembly components. The tool and tool holder in particular must be changed periodically to replace worn or damaged units. Worn tool holders are particularly difficult to remove from a base, and care must be taken to prevent damage from occurring to the base when removing worn or damaged holders. If the sleeve is not removed from the base in the direction of the base bore, the removal of the sleeve can damage the base bore necessitating replacement of the base as well as the tool holder.

Accordingly, there is a need for a cutting tool holder extraction device that extracts a tool holder from a base while minimizing damage to the base during the holder extraction operation.

### SUMMARY OF THE INVENTION

In accordance with an aspect of the invention, a cutting tool holder extraction devise comprising a cup, having a back portion having a rearward socket and a front portion having a forward tool socket, and a spacer section having an axial bore with a back orifice opening in the bottom of the rearward socket and a front orifice opening in the bottom of the tool socket; an expandable jack, the jack having an axial bore, and a front face; the front face of the jack is removably engageable with the rearward socket of the cup; a threaded bolt, the bolt having a front end and a rear end, the bolt removably disposable through the cup bore and through the jack bore; and at least one nut, removably attachable to the threaded bolt.

These and other aspects of the present invention will be more fully understood following a review of this specification and drawings.

### BRIEF DESCRIPTION OF THE DRAWINGS

FIG. 1 is a perspective view of a base and a cutting tool holder.

FIG. 2 is a side view of a base and a cutting tool holder.

FIG. 3 is a front view of a base and a cutting tool holder.

FIG. 4 is a side view of the cutting tool holder extraction device as assembled, in accordance with an aspect of the invention.

FIG. 5 is a cross sectional view of the cutting tool holder extraction device in accordance with an aspect of the invention, attached to a base and a cutting tool holder before removal of the holder.

FIG. 6 is a cross sectional view of the cutting tool holder extraction device in accordance with an aspect of the invention, attached to a base and a cutting tool holder, after removal of the holder.

FIG. 7 is a cross sectional view of the cutting tool holder extraction device in accordance with an aspect of the invention, attached to a base and a cutting tool holder, after removal of the holder

FIG. 8 is an exploded side view of the cutting tool holder extraction device in accordance with an aspect of the invention, and a base and a cutting tool holder.

FIG. 9 is an exploded top view of the cutting tool holder extraction device in accordance with an aspect of the invention, and a base and a cutting tool holder.

FIG. 10 is a top view of a cup portion of the cutting tool holder extraction device in accordance with an aspect of the invention.

FIG. 11 is a side view of a cup portion of the cutting tool holder extraction device in accordance with an aspect of the invention.

FIG. 12 is a top view of a tool holder.

FIG. 13 is a side view of a tool holder.

### DETAILED DESCRIPTION

The following description is for purposes of illustrating various aspects of the invention only and not for purposes of limiting the scope of the invention.

Referring to the Figures, there is illustrated a cutting tool holder extraction device, generally designated as reference number 10, in accordance with various aspects of the invention. It will be appreciated that the invention has application to various kinds of tool holder extraction. Exemplary operations include extraction of holders from bases, that without limitation include, road planing (or milling), coal mining, concrete cutting, and other kinds of cutting tool assemblies wherein a cutting tool with a hard cutting member impinges against a substrate (e.g., earth strata, pavement, asphaltic highway material, concrete, and the like) breaking the substrate into pieces of a variety of sizes including larger-size pieces or chunks and smaller-sized pieces including dust-like particles. In addition, it will be appreciated that the cutting tool holder extraction device 10 of the invention may be manufactured in various sizes and dimensions depending upon the desired application of the assembly.

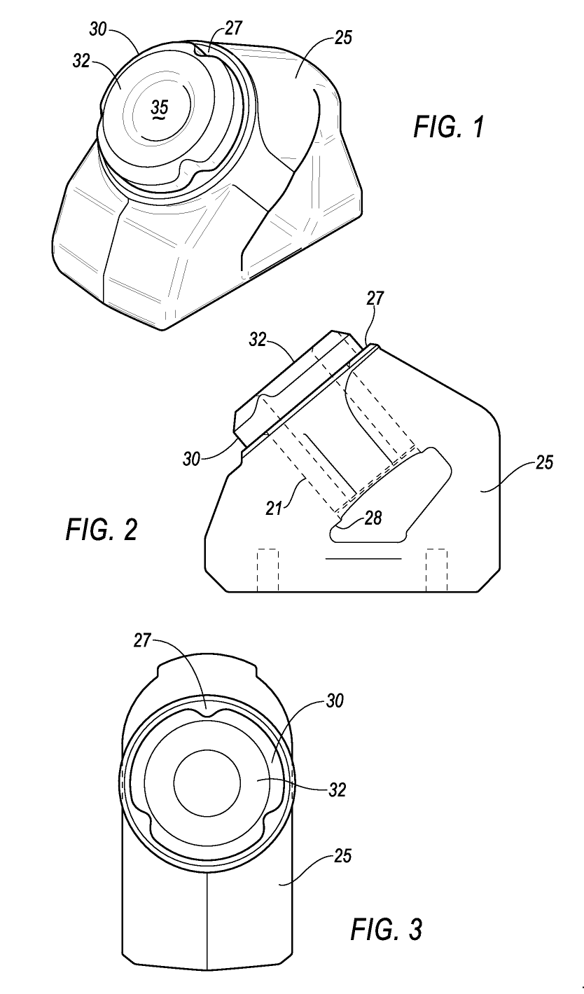

Referring to the FIGS. 1, 2, 3 and 6 there is illustrated representative cutting tool base and holder assemblies. Base 25 is fixably attached to the surface of a rotatable drum (not shown). Base 25 has a front face 27 and a back face 28 and a bore 26 extending from said front face 27 to said back face 28. A tool holder 30 is removably disposed in the bore 26 of base 25. Each tool holder 30 has a head portion 31 having a forward face 32, a rearwardly extending shank 33, a rear face 34, and an axial bore 35 extending through said tool holder head portion 31 and shank 33, from said forward face 32 to said rear face 34 (FIG. 13). Cutting tools (not shown) are removably attachable to tool holder 30 within the tool holder bore 35. The shank 33 of tool holder 30 is removably disposable within base bore 26 and is held in place by a press fit and/or a detachable retainer (not shown in the figures). The tight fit between the tool holder shank 33 and the base bore 26 and the dust and particulates that infiltrate any gaps between the tool holder shank 33 and the base bore 26 during operation of the cutting tool assembly results in a secure attachment of the holder shank 33 within the base bore 26.

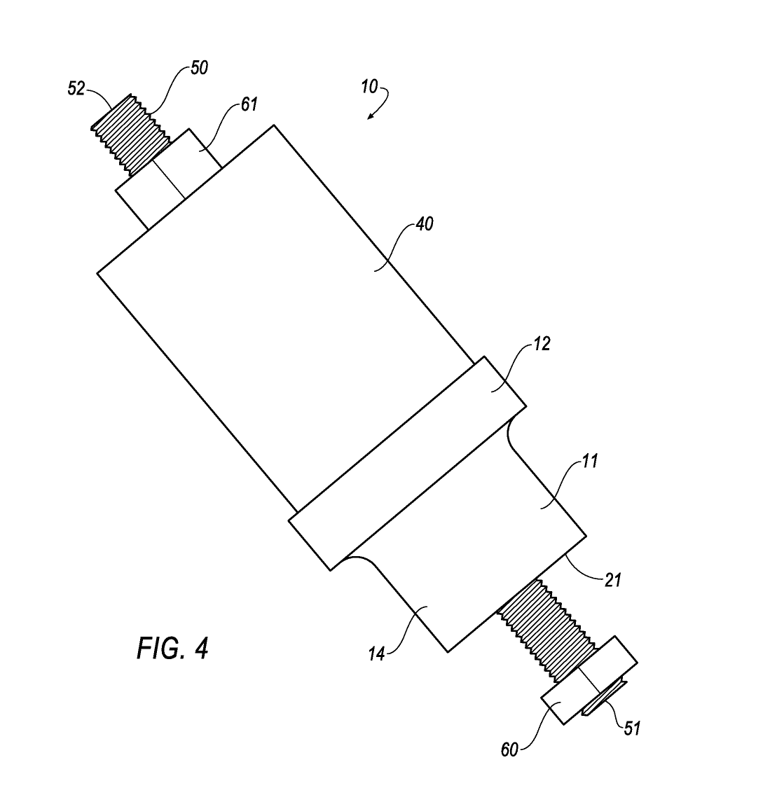

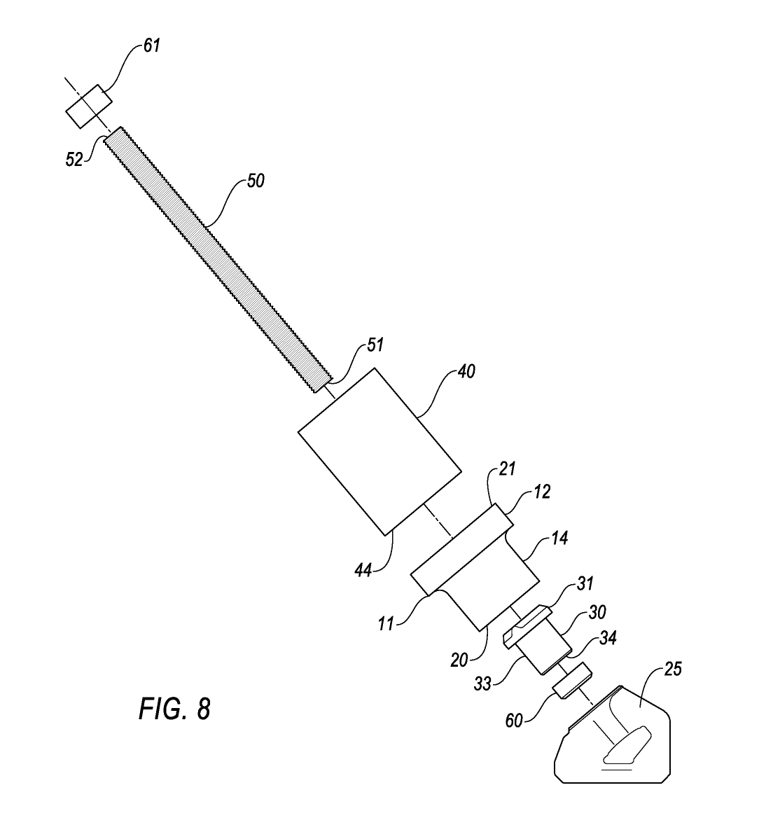

Referring to FIGS. 4-9, there is illustrated in detail the cutting tool holder extraction device 10 of the invention. The cutting tool holder extraction device 10 is adapted for removing a tightly engaged tool holder from the bore of a base block in a cutting tool assembly. Cutting tool holder extraction device 10 is comprised of a tool cup 11, a jack 40, a bolt 50 and at least one threaded nut 60.

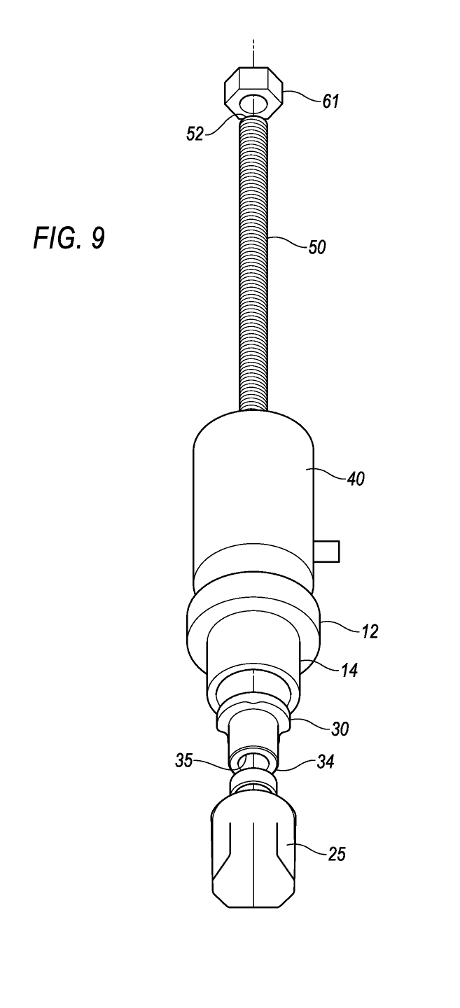

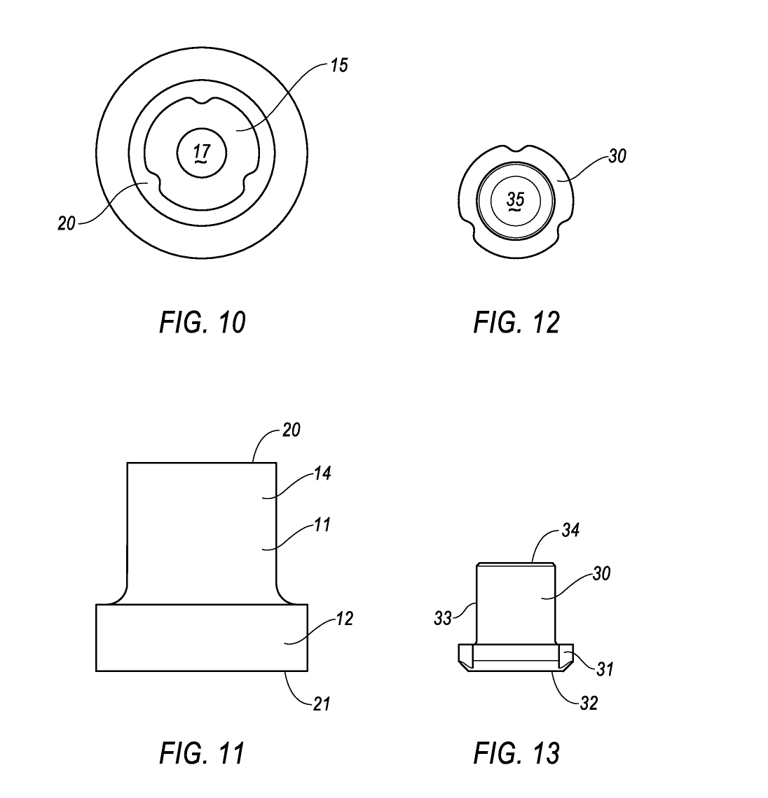

Tool cup 11 is comprised of a back portion 12 having a jack socket 13 and a front portion 14 having a tool socket 15 and a spacer section 16 having an axial bore 17 with an back orifice 18 opening in the bottom of the jack socket 13 and a front orifice 19 opening in the bottom of the tool socket 15. Tool socket 15 terminates at forward face 20. Jack socket 13 terminates at rearward face 21. Cup 11 is attachable at jack socket 13 to a jack 40 capable of expanding and contracting. The tool socket 15 of cup 11 is keyed in a shape that corresponds to the shape of the head portion 31 of a tool holder as shown in FIGS. 9, 10 and 12. In the preferred embodiment the tool holder head 31 is shaped to expose a portion of the base front face 27, however any exposed portion of the base 25 frontal area would suffice to enable tool holder removal from base 25.

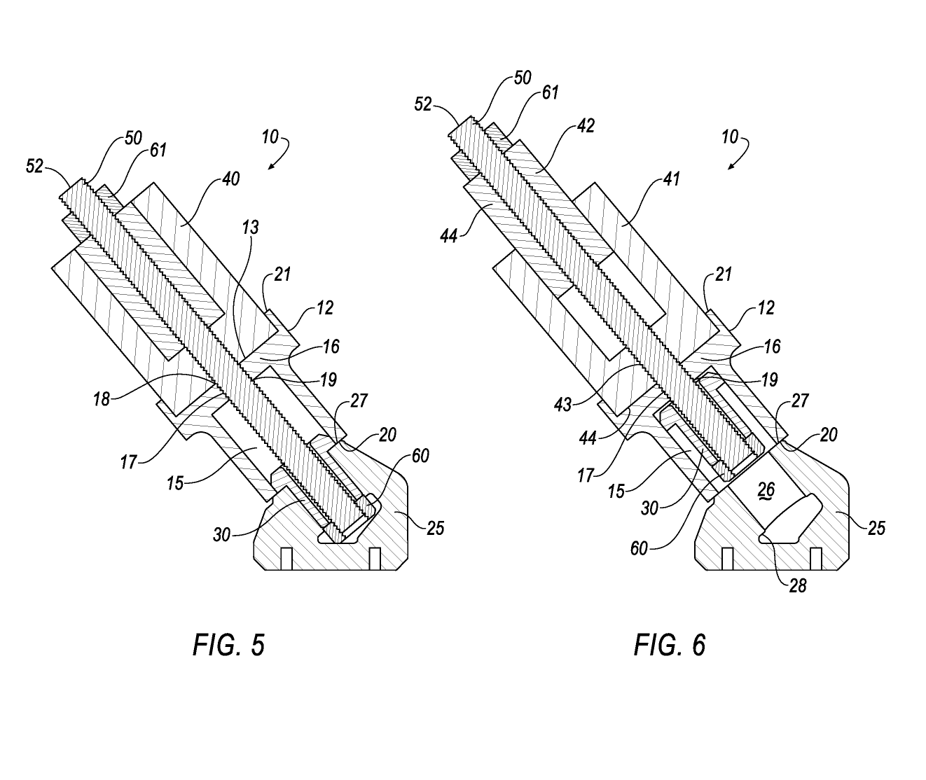

In the preferred embodiment as shown in FIGS. 5, 6 and 7, jack 40 has at least two concentric sleeves, 41 and 42 that expand and contract axially, and an axial bore 43 extending through both sleeves 41 and 42. Jack 40 may be any expandable device capable of expanding and contracting against loads of 20 tons or greater. Preferred jacks are hydraulic cylinders. Particularly preferred jacks are hydraulic cylinders having a longitudinal bore capable of removably receiving a bolt 50.

Bolt 50 is a threaded bolt having a front end 51 and a back end 52. Threaded nut 60 is removably attachable to bolt 50 at front end 51 and a second nut 61 is removably attached to threaded bolt 50 at back end 52. In another embodiment (not shown), bolt 50 may have a fixed head at one end and threads for engaging a nut at the opposite end.

In operation, cup 11 is placed over the head portion 31 of tool holder 30 and positioned with cup forward face 20 adjacent base block front face 27. Nut 61 is threaded onto end 52 of bolt 50. Bolt 50 is inserted through the axial bore 35 of tool holder 30 until the front end 51 of bolt 50 extends beyond rear face 34 of tool holder 30. Nut 60 is threaded onto bolt 50 at engagement end 51 as shown in FIG. 5. A washer (not shown) may optionally be placed on front end 51 between rear face 34 and nut 60. Nut 61 can optionally be replaced by a fixed bolt head. When jack 30 is activated, cylinder face 44 pushes against the bottom of cup jack socket 13, and socket front face 20 pushes against the base front face 27. Nut 60 attached to bolt 50 applies pressure on the rear face 34 of tool holder 30 in the direction of the jack 40 along the axis of bolt 50. Simultaneously the cup front face 20 positioned against base block front face 27 inhibits movement of the cup 11 in relation to base 25. As jack 40 expands, sleeve 11 is pulled from bore 26 of base 25 and into socket 13 of cup 11 as shown in FIG. 6.

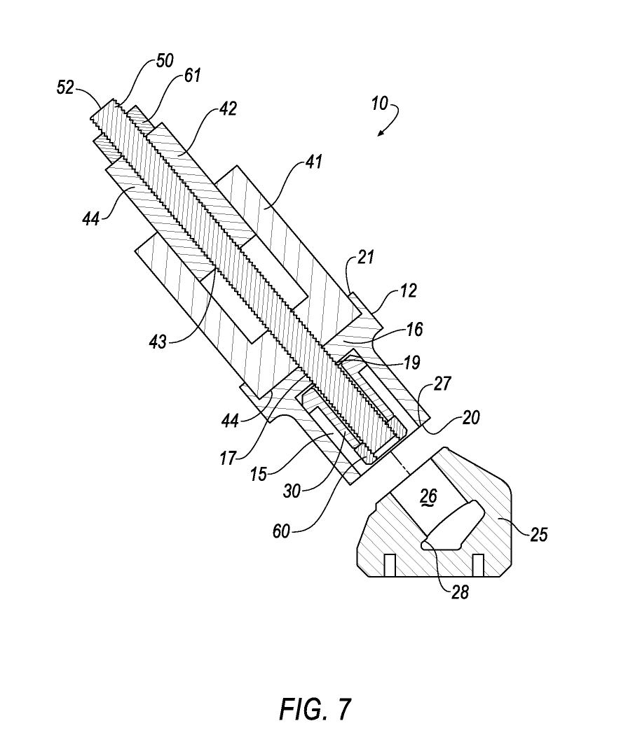

As shown in FIGS. 6 and 7, cup 11 must be of sufficient depth to completely encompass tool holder 30 without tool holder 30 impacting the bottom of the socket 13 to achieve compete removal from base block bore 26. In a preferred embodiment of the invention, socket 13 is shaped to correspond to the shape of the tool holder head portion 31. Mating the shape of socket 13 to tool holder head portion 31 inhibits lateral movement and rotation of tool holder 20 during extraction, thereby minimizing damage to the base bore 102.

Whereas particular aspects of this invention have been described above for purposes of illustration, it will be evident to those skilled in the art that numerous variations of the details of the present invention may be made without departing from the invention as defined in the appended claims. For example, various shapes, sizes or configurations of tool cups, jacks, bolts and threaded nuts are within the scope of this invention as defined in the appended claims.

What is claimed is:

1. A cutting tool holder extraction devise comprising:
a cup having a back portion having a rearward socket and a front portion having a forward socket and a spacer section having an axial bore with an back orifice opening in the bottom of the rearward socket and a front orifice opening in the bottom of the forward socket;
an expandable jack, said jack having an axial bore, and a front face; said front face removably engagable with said rearward socket of said cup;
a threaded bolt, said bolt having a front end and a rear end, said bolt removably disposable through said cup bore and through said jack bore; and
at least one nut, removably attachable to said threaded bolt.

2. The cutting tool holder extraction device of claim 1 wherein said jack is a hydraulic cylinder.

3. The cutting tool holder extraction device of claim 1 wherein said cup forward socket is keyed to match the head portion of tool holder.

4. A device for extracting a tool holder from engagement with a base block mounted on a rotatable drum wherein said tool holder has a head portion having a forward face, a rearwardly extending shank, a rear face, and an axial bore extending through said tool holder head portion and said shank from said forward face to said rear face, and said base block having a body having a front face and a back face and a bore extending from said front face to said back face, said tool holder shank being tightly fitted within said base block bore, said device comprising:
a) a cup having a front face defining a front socket and a rear face defining rear socket and a spacer portion separating said front socket and said rear socket, said spacer portion having a bore; said bore having rear orifice in said rear socket and a front orifice in said front socket;
b) an expandable device attached to said cup rear face, said expandable device having an axial bore;
c) a threaded bolt having a front end and a back end, said bolt removable disposable within said expandable device bore; and
c) a nut removably attachable to said threaded bolt;
wherein said cup front socket is keyed to correspond to said tool holder head portion and said cup face is configured to contact said base front face;
wherein said bolt is removable disposable through said tool holder axial bore;
wherein said bolt front end is extendible from said tool holder rear face; and
wherein and said nut is attachable to said bolt front end adjacent to said tool holder rear face.

5. A cutting tool holder extraction kit comprising:
A cup having a front socket and a back socket with a bore disposed between said front socket and said back socket, a jack, a threaded bolt and at least one threaded nut.

6. The cutting tool holder extraction kit of claim 5 wherein said cup back socket is keyed to match the head portion of a tool holder.

7. The cutting tool holder extraction kit of claim 5 wherein said jack is a hydraulic cylinder.
